(19) United States
(12) Patent Application Publication
(10) Pub. No.: US 2006/0214332 A1
(43) Pub. Date: Sep. 28, 2006

(54) METHOD OF MOLDING RUBBER WITH MINIMAL WASTE

(75) Inventors: Michel Fernandes, North Dartmouth, MA (US); Diamantino Fidalgo, Acushnet, MA (US)

Correspondence Address: BARLOW, JOSEPHS & HOLMES, LTD., 101 DYER STREET, 5TH FLOOR, PROVIDENCE, RI, 02903, US

(73) Assignee: POLYNEER, INC., New Bedford, MA (US)

(21) Appl. No.: 11/277,626

(22) Filed: Mar. 28, 2006

Related U.S. Application Data
(60) Provisional application No. 60/665,891, filed on Mar. 28, 2005.

(51) Int. Cl. B29C 45/24

(52) U.S. Cl. 264/328.2; 425/553; 264/328.4

(57) ABSTRACT

A method of waste-less molding of rubber is disclosed. The method includes, in a first step, providing unvulcanized rubber that forms rubber of a predetermined tensile strength when vulcanized. In a second step, a mold having an injection port and a mold cavity is provided. The injection port and mold cavity are in fluid communication for forming a rubber part within the mold cavity and a sprue connected thereto extending into the injection port. In a third step, the injection port is configured to have a first point of a first cross-sectional area and a second point of a second cross-sectional area wherein the ratio of the first cross-sectional area to the second cross sectional area with regard to the tensile strength of the rubber causes the sprue to fail at the first point prior to failing at the second point when sufficient tensile stress is applied to the part.

### BACKGROUND OF THE INVENTION

1. Field of the Invention

The present invention relates generally to methods of molding rubber and more particularly to a method of molding rubber that minimizes the waste rubber produced.

2. Background of the Related Art

Methods of transfer molding are well known in the art. Transfer molding is used extensively in both the plastics and rubber industries. A rubber transfer process is comprised of a “hot” or “cold” (temperature controlled) transfer pot system, which is frequently just called the “transfer pot” in the industry, and a mold having a mold cavity for forming the desired part. A typical “cold” transfer pot system is comprised of a chamber for holding material to be molded, a piston that drives the material into a mold, and an insulator board. A transfer mold can be run in a compression press machine, where the material is manually put into the pot or in an injection press where the material is automatically injected into the pot. Waste-less molding is the art in which a “cold” transfer pot system is used to create a temperature gradient differential between the transfer pot and the mold. This technique allows the material to cure or vulcanize up to a particular depth into the transfer pot, thus minimizing the waste and allowing the following material to be used for the repeated molding cycle(s).

The mold cavity is immediately adjacent to the insulator board. Running through the insulator board and into mold cavity of the mold is an injection port. Material is forced by the transfer pot, through the injection port in the insulator board and into the mold cavity to form the desired part. During the molding process, using a waste-less technique, waste material is only formed in the injection ports of the mold and insulator board. These pieces of waste material are called sprues, mold sprues or molded sprues. The waste material frequently can weigh more than the desired molded part when not using a waste-less technique, and because rubber undergoes a chemical reaction called vulcanization in order to set and form the desired part, waste produced in the molding process can not be recycled as it is with plastics. In the auto industry and other specialty industries, where designer rubber compounds are often used for specialized applications the amount of the waste product often exceeds the actual part and thus makes the parts quite expensive. Also, the environmental effect of disposing waste material is significantly reduced. Accordingly, there is still a need for a method of molding rubber that further minimizes the amount of waste material produced in molding a desired rubber part.

Because many rubber molding applications can be automated, it is desirable that the mold sprues be easily separable from the molded parts. Current methods have used a unified sprue, typically called a cull pad, wherein the sprues of the multiple molded parts are interconnected with gates to allow automatic equipment or people to easily separate the sprue from the parts. This technique, however, suffers from a disadvantage in that it produces too much waste material (additional gates) that cannot be recycled. Another current technique involves using a piece of porous cloth between the insulator board and the sprue. During the transfer of the rubber into the mold cavity, the rubber passes through the porous cloth. As the rubber sets, however, it fuses to the cloth. The sprues can then be easily separated from the mold by peeling the piece of cloth away from the mold. This technique, however, suffers from the disadvantage that the part formed by this process frequently has fibers from the cloth embedded in it, making the part, at best, undesirable and at worst, unusable. Also, the cloth can not be re-used, increasing the cost of producing a part. Therefore, there is a need for a method to easily separate the sprues from the molds of mass produced rubber parts.

Another problem that must be overcome in molding rubber is minimizing the mess caused by un-vulcanized rubber that leaks from a transfer pot or that is drawn out by the vulcanized rubber in the sprue. If the sprues from molded parts are not removed with care, un-vulcanized rubber clinging to the end of the vulcanized rubber end of the sprue may be transferred to the outside portion of the mold, the mold and transfer pot matting surfaces, or onto another undesirable surface that could interfere with the production of the molded parts. These unwanted deposits can enhance the effects of mold fouling. Therefore there is a need for a method to remove the vulcanized rubber sprues from a mold that minimizes the opportunity for the inadvertent transfer of un-vulcanized rubber onto other surfaces.

### SUMMARY OF THE INVENTION

The present invention solves the problems of the prior art by providing a novel molding method and apparatus. Particularly, the method and apparatus of the present invention involves selecting the correct ratio of interface sizes between the part and the sprue and between the sprue and the un-vulcanized rubber with respect to the tensile strength of the particular rubber being used to consistently allow for only the desired interface tearing when the mold separates from the insulator board. The next step in method of the present invention involves using a sprue removal system, such as a guillotine system or a vacuum system, to forcibly and accurately remove and dispose of the sprues connected to the remaining interface to allow for subsequent molding of other parts. These methods allow for minimizing the waste, eliminating mold fouling due to loose un-vulcanized rubber, and the ability to fully automate a rubber molding process.

### BRIEF DESCRIPTION OF THE DRAWINGS

These and other features, aspects, and advantages of the present invention will become better understood with reference to the following description, appended claims, and accompanying drawings where:

FIG. 1 is a side cross-sectional view of the preferred embodiment of the present invention;

FIG. 2 is a side view of the preferred embodiment of the present invention;

FIG. 3 is a side cross-sectional view of the guillotine system of the preferred embodiment of the present invention; and

FIG. 4 is a top view of the guillotine system of the preferred embodiment of the present invention.

### DESCRIPTION OF THE PREFERRED EMBODIMENT

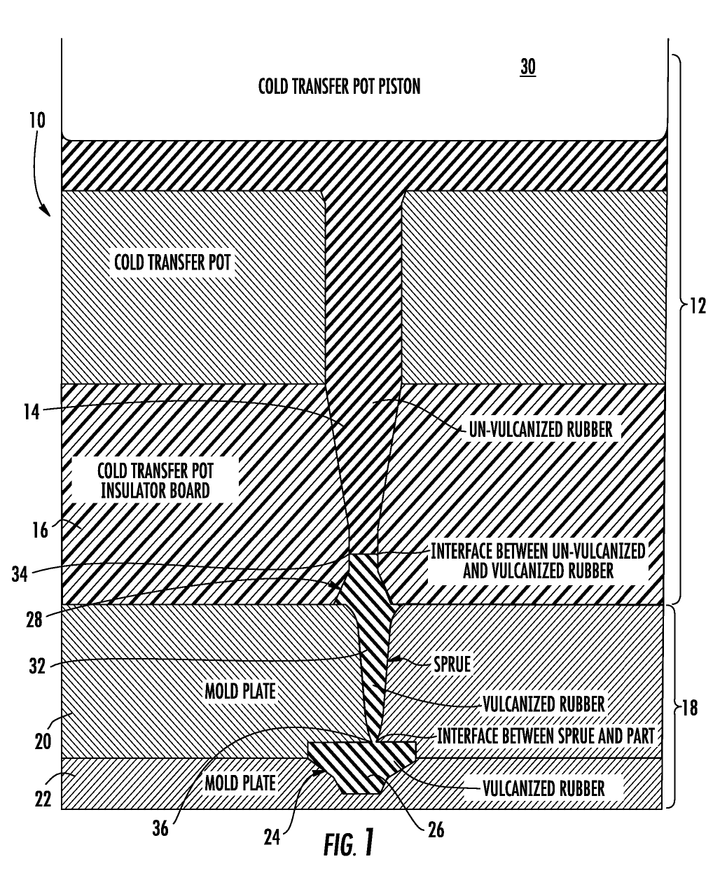

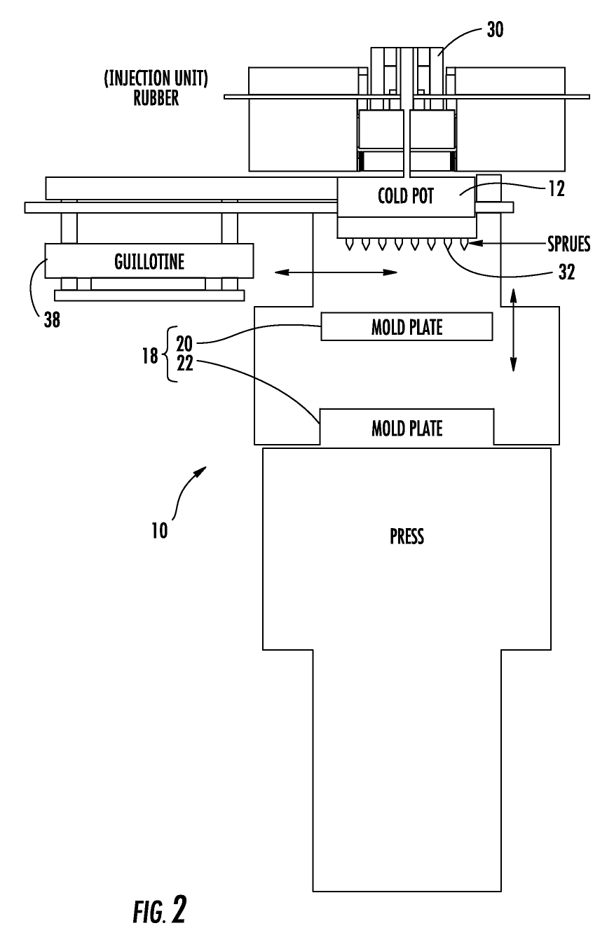

Referring now to FIGS. 1 and 2, a molding press for injection transfer molding of a rubber part, such as a rubber grommet for use in the auto industry, is shown generally at 10. The molding press 10 includes a cold transfer pot system 12 that contains the un-vulcanized rubber material 14 to be molded. The transfer port system 12 includes an insulator board 16. Adjacent to the insulator 16 is a typical two-plate mold 18 that has a top plate 20 and a bottom plate 22. Between the mold plates 20, 22 is the mold cavity 24 forming the shape of the desired part 26. The mold cavity 24 is in fluid communication with the transfer pot 12 through an injection port 28. Although one injection port 28 is shown, multiple injection ports 28 may be used depending the size and shape of the mold cavity 24 to ensure that the mold cavity 24 is filled with un-vulcanized rubber material 14 during the molding process. Selecting the number and positioning of the injection ports 28 to obtain a proper fill of the mold cavity 24 is well known in the art. A piston 30 in the transfer pot 12 is used to drive the un-vulcanized rubber 14, through the injection port 28 and into the mold cavity 24 of the mold 18, where heat is applied to the un-vulcanized rubber 14 causing it to set and form the vulcanized rubber part 26.

During the vulcanization of the rubber 14, not only is the rubber 14 in the mold set to form a part 26, but some rubber 14 contained in the injection port 28 within the insulator board 16 also sets to form the mold sprue 32. This occurs due to the natural transfer of heat from the mold 18 and the rubber 14 contained therein to the rubber 14 contained within the insulator board 16. The point where the rubber vulcanizes within the insulator board 16 forms an interface 34 with the rubber that does not vulcanize or that only partially vulcanizes due to insufficient heat. An interface 36 also forms between the mold sprue 32 and the part 26 contained within the mold cavity 24. The size of the injection port 28 within the insulator board 16 is selected depending on the properties of the particular mixture of rubber compounds 14 being used. The key, however, is to select the correct ratio of interface sizes 34, 36 with respect to the tensile strength of the vulcanized rubber in order to ensure that the interface 36 between sprue 32 and the part 26 separate first.

After the rubber 14 has vulcanized, the mold 18 is separated from the insulator board 16. As the mold 18 separates from the insulator board 16, tensile stress is placed on the rubber contained therein. In particular, the tensile stress at the two interfaces 34, 36 is most prominent. However, the interface 36 between the sprue 32 and the part 26 will fail before the interface 34 between the sprue 32 and the un-vulcanized rubber 14 because the tensile strength is greater there. The proper selection of the ratios of the diameters of the injection ports at the two respective interface forming locations 34, 36 with regard to the properties of the particular rubber 14 chosen is critical to the successful separation of the part 26 from the sprue 32.

After the mold 18 has been separated from the transfer pot system 12 of the molding press 10, the parts 26 may be extracted from the mold 18 by separating the mold plates 20, 22 through use of automation or even by hand. The parts 26 may then be passed on for further processing as desired.

Before the molding of new parts 26 may begin again, however, the sprues 32 must be extracted from the injection port(s) 28 of the insulator board 16. As stated earlier, the vulcanized portion of the sprue 32 clings to the partially-vulcanized or un-vulcanized rubber 14 remaining in the injection port 28 of the insulator board 16 and transfer pot 12. To remove the sprue 32 it must be forcibly pulled from the insulator board 16.

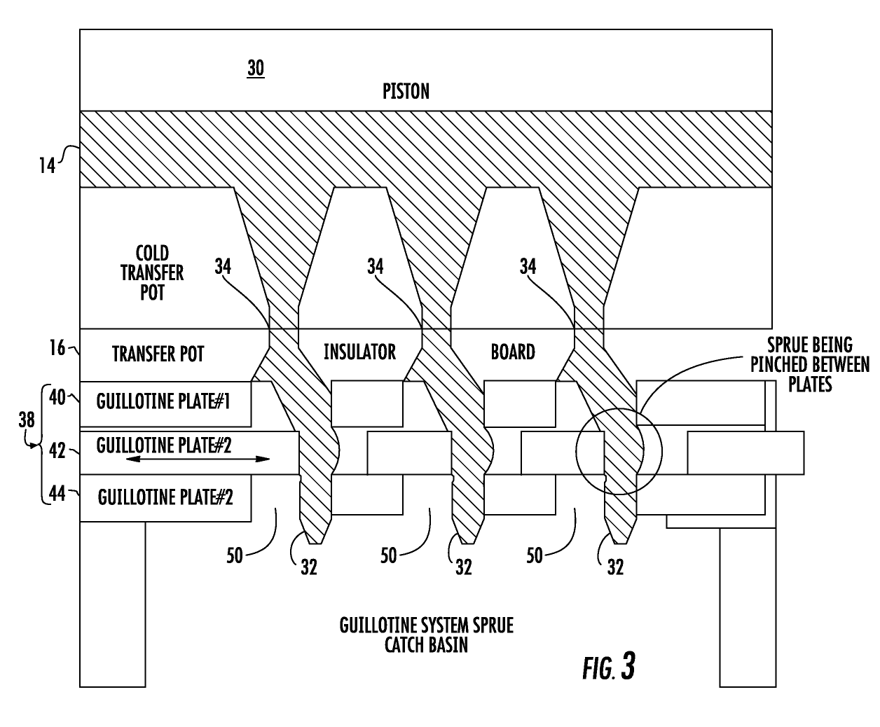

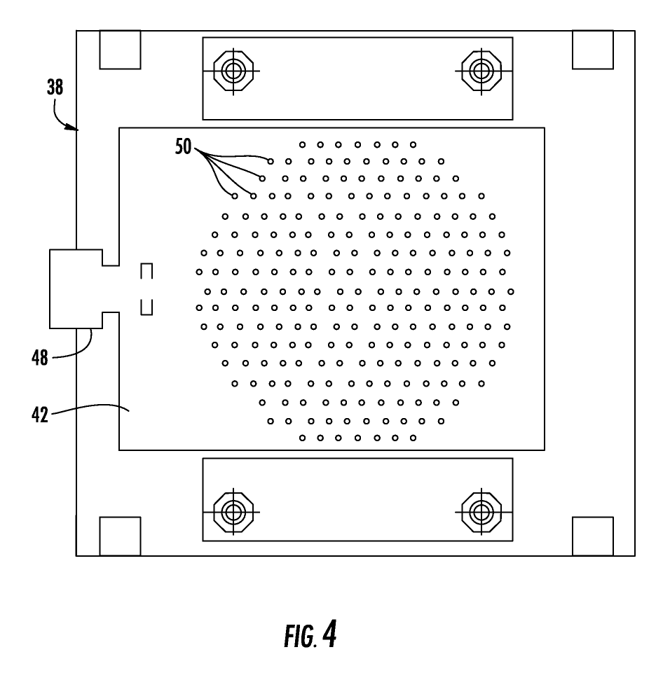

The preferred method to remove the sprues 32 as defined by the present invention is to use a guillotine system 38 as shown in FIG. 2-4. The guillotine system 38 has a griping system to grab the sprues 32, which may be implemented in many ways. In the preferred embodiment, the guillotine system 38 includes three plates 40, 42, 44 adjacent to one another as shown in FIG. 3. The second plate 42, located between the first plate 40 and third plate 44, slides laterally relative to the first 40 and third 44 plate. This movement is accomplished by a pneumatic piston 48 (shown in FIG. 4), but other means could be equally effective. Holes 50 are bored through the plates 40, 42, 44 and are designed to receive the sprues 32 therein as shown in FIGS. 3-4. When the second plate 42 is slid out of alignment with the first 40 and third 44 plates, the plates 40, 42, 44 together will act as gripping device by pinching anything located within the bore of the hole 50. The guillotine system 38 slides under the insulator board 16 and aligns the holes 50 with the sprues 32 dangling therefrom. The guillotine system 38 then grips the sprues 32 by sliding the second plate 42 laterally (FIG. 3), thereby pinching the sprues 32 between the plates 40, 42, 44, and then pulls the sprues 32 downwardly with sufficient force to overcome the bond at the interface 34 between the sprue 32 and the partially vulcanized and un-vulcanized rubber 14 within the injection port 28. As the sprues 32 are removed from the injection port 28 they may drag un-vulcanized and partially vulcanized rubber 14 with them. Therefore, it is important that the guillotine system 38 draw the sprues 32 directly away from the insulator board 16 without significant lateral movement. This will ensure that any unwanted rubber deposits are minimal. The guillotine system 38 then slides out from underneath the insulator board 16 and disposes of the waste sprue material 32. The molding process may then be repeated to produce more parts 26.

Although the present invention has been described with reference to a vertical press system, it may easily be modified for use with a horizontal press system.

In an alternative embodiment, the tensile strength of the interfaces 34, 36 may be reversed in that the interface 34 between the sprue 32 and the un-vulcanized rubber 14 may be designed to fail first rather than the interface 36 between the sprue 32 and the part 26 as in the method of the preferred embodiment. In the alternative embodiment, the guillotine system 38 then slides over the mold 18 to subsequently remove and dispose of the sprues 32 sticking up from the top of mold 18.

Therefore, it can be seen that the present invention provides a unique solution to the problems of the prior art by providing a novel method of molding rubber that further minimizes the amount of waste material produced in the sprue 32, a novel method of easily removing and disposing of the sprues 32 from the parts 26 and transfer pot system 12, minimizes the opportunity for unwanted stray deposits of un-vulcanized rubber material, and allows for the rubber molding process to be fully automated.

It would be appreciated by those skilled in the art that various changes and modifications can be made to the illustrated embodiments without departing from the spirit of the present invention. All such modifications and changes are intended to be within the scope of the present invention except as limited by the appended claims.

What is claimed is:

1. A method of waste-less molding of rubber, comprising the steps of:
providing unvulcanized rubber for forming rubber having a predetermined tensile strength;
providing a molding press having a transfer pot for holding the unvulcanized rubber;
providing a mold having a mold cavity;
providing an injection port in fluid communication with the mold cavity and with the transfer pot;
forcing unvulcanized rubber into the mold cavity through the injection port with the transfer pot and the molding press;
vulcanizing the unvulcanized rubber in the mold cavity and injection port to form a part and a sprue, respectively;
separating the mold from the transfer pot thereby causing the sprue to separate from one of the mold or the transfer pot;
removing the sprue from one of the mold or the transfer pot; and
removing the part from the mold cavity.

2. The method of claim 1, further comprising the steps of:
forming a first interface between the unvulcanized rubber and the sprue; and
forming a second interface between the sprue and the part.

3. The method of claim 2, wherein separating the mold from the transfer pot causes tensile stress to be applied to the part and the sprue wherein the first interface fails prior to the second interface

4. The method of claim 2, wherein while separating the mold from the transfer pot causes tensile stress to be applied to the part and the sprue wherein the second interface fails prior to the first interface.

5. The method of claim 1, wherein the step of removing the sprue from one of the mold or the transfer pot, comprises:
grasping the sprue; and
pulling the sprue free from one of the mold or the transfer pot.

6. The method of claim 1, wherein a guillotine system is used to grasp and remove the sprue from one of the mold or the transfer pot.

7. A method of waste-less molding of rubber, comprising the steps of:
providing unvulcanized rubber that forms rubber of a predetermined tensile strength when vulcanized;
providing a mold having an injection port and a mold cavity, the injection port and mold cavity being in fluid communication for forming a rubber part within the mold cavity and a sprue connected thereto extending into the injection port; and
configuring the injection port to have a first point of a first cross-sectional area and a second point of a second cross-sectional area wherein the ratio of the first cross-sectional area to the second cross sectional area with regard to the tensile strength of the rubber causes the sprue to fail at the first point prior to failing at the second point when sufficient tensile stress is applied to the part.

8. The method of claim 7, wherein the first point of the injection port is located immediately adjacent to the mold cavity.

9. The method of claim 7, wherein the first point of the injection port is located adjacent to the transfer pot.

10. An apparatus for waste-less molding of rubber, comprising,
a transfer pot for holding unvulcanized rubber that, when vulcanized, forms rubber of a predetermined tensile strength;
a mold having a mold cavity for forming a part of rubber;
an injection port in fluid communication with the mold cavity and the cold transfer pot, the injection port having a first point of a first cross-sectional area and a second point or a second cross-sectional area, the injection port forming a sprue therein during vulcanization of the rubber;
means for forcing unvulcanized rubber from the transfer pot, through the injection port and into the mold cavity of the mold;
means for vulcanizing the rubber;
means for separating the mold from the transfer pot;
the first cross-sectional area configured and arranged to form a first interface between the unvulcanized rubber and vulcanized rubber of the sprue after vulcanization;
the second cross-sectional are configured and arranged to form a second interface within the vulcanized rubber within the mold cavity and the injection port between the sprue and the part.

11. The apparatus of claim 10, further comprising means for removing the sprue from the injection port.

12. The apparatus of claim 10, wherein the means for forcing unvulcanized rubber from the transfer pot, through the injection port and into the mold cavity of the mold comprises a piston.

13. The method of claim 10, wherein the means for separating the mold from the transfer pot causes tensile stress to be applied to the part and the sprue wherein the first interface fails prior to the second interface

14. The method of claim 10, wherein while separating the mold from the transfer pot causes tensile stress to be applied to the part and the sprue wherein the second interface fails prior to the first interface.
